(19) United States
(12) Patent Application Publication
(10) Pub. No.: US 2008/0319133 A1
(43) Pub. Date: Dec. 25, 2008

(54) Method of adhering a thermoplastic elastomer member to a glass sheet

(76) Inventor: Julia B. MacLachlan, Toledo, OH (US)

Correspondence Address: MARSHALL & MELHORN, LLC, FOUR SEAGATE - EIGHTH FLOOR, TOLEDO, OH, 43604, US

(21) Appl. No.: 12/214,033

(22) Filed: Jun. 16, 2008

Related U.S. Application Data
(60) Provisional application No. 60/936,427, filed on Jun. 20, 2007.

(51) Int. Cl. C08L 75/04

(52) U.S. Cl. 525/123

(57) ABSTRACT

The present invention relates to a method of adhering an elastomeric member formed of a thermoplastic elastomer (TPE) material, to a glass sheet, in particular, a blend of a styrene-ethylene-butylene-styrene (SEBS) copolymer and a thermoplastic polyurethane (TPU) material utilizing one or more of an isocyanate-based primer and a silane-based primer.

### RELATED APPLICATION

This application is claiming the benefit, under 35 U.S.C. 119(e), of the provisional application filed Jun. 20, 2007 under 35 U.S.C. 111 (b), which was granted Ser. No. 60/936,427. This provisional application is hereby incorporated by reference.

### BACKGROUND

The invention relates to bonding an elastomeric member, such as a peripheral molding, to a glass sheet.

For some years now, it has been common practice in the automotive glazing industry to produce “encapsulated” vehicle windows; that is, a vehicle window having an elastomeric member extending around all, or a portion of, the periphery of such vehicle window. Various materials have been utilized to form such elastomeric members, and various methods of molding such elastomeric members have been employed. Among the most common are multi-component polyurethane (PU) materials molded by reaction injection molding (RIM) and polyvinylchloride (PVC) molded by injection molding. Bonding such materials to glass is problematic, and it has been found to be essential to utilize adhesion-promoting materials, also known as primers, to increase bond strength, as well as the durability of the bond, between the polymeric material and the glass sheet.

As between PU and PVC, each has been found to be suitable for different applications. Where possible, however, it is advantageous to use PVC for encapsulation purposes, as it is substantially less expensive in terms of material costs. On the other hand, generally speaking, PU materials form stronger bonds to the glass. With an increasing emphasis on constructing vehicles of “environmentally friendly” materials, i.e., materials which can be beneficially recycled/reused, PVC has come under fire as posing an environmental hazard upon improper disposal. Thus, efforts have intensified to find materials which can replace PVC in vehicle window encapsulation. Among many other properties to be considered in finding such replacement materials are (1) cost, (2) ability to strongly bond to glass, and (3) ability to provide a good compression set for sealing purposes.

Use of thermoplastic elastomer (TPE) materials including SEBS or SBS polymers blended with various other polymeric materials have been described in the patent literature for encapsulation and related uses, for example:

U.S. Pat. No. 7,056,971 describes a thermoplastic elastomer which by itself is said to be oxygen-permeable, is provided with barrier properties against oxygen by melt-blending the TPE with a liquid polyisobutene oil plasticizer in an amount which does not render the plasticized elastomer tacky.

U.S. Pat. No. 7,026,028 describes a multi-layer molding containing a body part and a surface layer which at least partly covers the body part, which body part contains a cross-linked elastomer composition and which surface layer contains a thermoplastic elastomer (TPE). It is said that the TPE of the body part imparts good weatherability properties to the surface layer.

U.S. Pat. No. 7,015,284 describes a thermoplastic elastomer composition which can be over molded onto a hard substrate, such as a plastic or metal surface. The subject composition, when molded, is said to be odor-free, scratch resistant and colorable.

U.S. Pat. No. 6,984,688 describes a plasticized hydrogenated TPE block copolymer having blocks of a vinyl aromatic monomer and a conjugated diene monomer (HSBC) blended with polypropylene and free of filler material, is said to provide an injection-moldable composition for an article required to have specific properties related to tensile strength, tear strength, softness and haze, and it is essential that all of the aforementioned properties and the physical dimensions of the molded article remain substantially unchanged after immersion of the article in boiling water for 1 hour.

U.S. Pat. No. 6,846,571 describes a polymer blend said to be suitable for use in automotive floor covering applications. The polymer blends are said to be formable into sheet materials that are recyclable and which may exhibit low gloss and tactility similar to vulcanized rubber. The polymer blend is also said to exhibit good grain retention, abrasion resistance and heat and ultraviolet light stability.

U.S. Pat. No. 6,399,696 describes a thermoplastic elastomer composition said to have excellent sealing properties and which prevents the generation of gases such as volatile low molecular weight components, while a molded article made of such material is not sticky as the result of the use of fine particulates of ultra-high molecular weight polyethylene.

U.S. Pat. No. 5,221,782 describes a thermoplastic resin composition containing a partially cross-linked product prepared by dynamically heat-treating a thermoplastic resin and a rubbery substance in the presence of a specific compound such as a dihydroaromatic compound or a polymer thereof as a crosslinking agent and a poly-functional monomer and further incorporating a softening agent and/or an inorganic filler.

U.S. Pat. No. 5,149,736 describes styrene-ethylene-butylene-styrene triblock copolymer-oil compositions which are said to be temperature resistant and non-meltable. The compositions are said to be moldable under pressure at elevated temperatures.

It would be advantageous to find a thermoplastic elastomer (TPE) material which bonds to glass like PU, but at the lower cost of PVC, has good sealing properties, and which meets other stringent criteria of vehicle manufacturers for such materials.

### SUMMARY OF THE INVENTION

The present invention relates to a method of adhering a member formed of a TPE material, in particular, a blend of a styrene-ethylene-butylene-styrene (SEBS) copolymer and a thermoplastic polyurethane (TPU) material, to a glass sheet, utilizing one or more of an isocyanate-based primer and a silane-based primer. Bond strengths which exceed the cohesive strength of the TPE material, even after weathering, can be achieved by utilizing the materials of the present invention.

### DETAILED DESCRIPTION OF THE INVENTION

The present invention relates to a thermoplastic elastomer (TPE) material comprising a blend of a styrene-ethylene-butylene-styrene (SEBS) copolymer and a thermoplastic polyurethane (TPU) that is bonded to a glass substrate by molding the SEBS/TPU to the periphery of the substrate by conventional injection molding methods, or by bonding a preformed elastomeric member made from the subject SEBS/TPU material to the periphery of the glass substrate. While the subject SEBS/TPU material exhibits some level of adhesion to a glass substrate without specific treatment of the glass surface, or with use of a_single primer, certain vehicle manufacturers require a level of adhesion which cannot be met by the SEBS/TPU material alone, or by utilizing a single adhesion-promoting primer.

To significantly increase the strength and durability of the bond between the subject SEBS/TPU material and the glass substrate, it has been found that a mixture of two adhesion-promoting primer materials, or a step-wise application of more than one adhesion-promoting primer material, is quite effective. More specifically, and preferably after thorough cleaning of the surface of the glass substrate to which the primer materials are to be applied, a mixture of a silane-based primer and an isocyanate-based primer is applied by any conventional means to at least a portion of the periphery of the glass substrate.

Alternatively, it may be desirable to, again, after first preferably cleaning the glass, initially apply a silane-based primer to the periphery of the glass substrate by any conventional application method, to be followed, within a specified period of time, by application of an isocyanate-based primer, also by any conventional application method, either manual or automated.

Examples of suitable silane-based primers include: Betaseal 43518™ (Dow Automotive), GC20™ (YH America), and Glasgrip 7780™ (Ashland Chemical Co.).

Examples of suitable isocyanate-based primers include: Betaseal 43520A™ (Dow Automotive), Sika 206G+P™ (Sika), and PC3™ (YH America).

Also, heating the glass substrate to a predetermined temperature has been found to enhance bond strength and durability. To maximize bond strength and durability the glass should be heated to a temperature in the range of 100° F. to 300° F., preferably, between 150° F. and 250° F.

Utilizing the aforementioned primer system, the strength of the bond formed between the SEBS/TPU material and the glass substrate has been found to exceed the strength of the SEBS/TPU material itself, the strength being dependent on the durometer of the material, which is typically between 50 Shore A and 90 Shore A. Bond durability is generally expected to be a minimum of 10 years under environmental conditions that would be seen by a typical vehicle. The SEBS/TPU material itself should also not change color or otherwise degrade in physical appearance to an extent that would be noticeable by, for example, the owner of the typical vehicle, for the above-noted 10 year period.

The SEBS/TPU material provides a good balance between its performance as, for example, a material from which a seal on a vehicle sunroof is formed, and cost. It is preferred that the subject SEBS/TPU material have a compression set in that is, the amount of elastic deformation which, can be tolerated by the material and still return to its original configuration, the range of 20-40%, preferably 20-30%, which will provide good sealing capability in sunroof seal applications and the like. At the same time, it is desirable that the cost of the SEBS/TPU material on a per unit of weight basis approach that of PVC, to the extent possible.

While not wishing to be bound by any theory, the inventors believe that in combining the silane-based and isocyanate-based adhesion-promoting primer materials, the silane-based primer, when applied directly to the surface of the glass substrate, acts as a coupling agent to provide a bond to the glass. The isocyanate-based primer material then forms a link between the silane material and the SEBS/TPU material. As previously noted, this functionality appears to exist whether the two primer materials are mixed, or applied separately in a step-wise fashion.

As previously noted, the scope of the present invention includes both in-situ molding of the SEBS/TPU material, as well as adhering elastomeric members preformed from the SEBS/TPU material, to a glass substrate.

While any conventional injection molding process may be used in connection with the present invention, a preferred process involves placing a sheet of glass, or a vehicle glazing formed from a sheet of glass, into a first mold half made to precisely position the glass in the mold, including having an area coinciding with at least a portion of the periphery of the glass sheet, which area constitutes one-half of a mold cavity that is capable of receiving the subject SEBS/TPU material in a flowable form upon injection into the mold. Preferably, prior to placement into the first mold half, the blend of primers, or multiple primer layers, have previously been applied to designated areas of the glass periphery. Typically, a second complementary mold half is brought into intimate contact with the first mold half, forming a mold cavity which takes the form of the profile of the elastomeric member that is to be bonded to the glass substrate. A sufficient quantity of the liquid SEBS/TPU material is injected to fill the mold cavity and in doing so, comes into bonding contact with the periphery of the glass sheet. Upon cooling for a sufficient time, the glass substrate with the solidified SEBS/TPU member molded on can be removed from the mold in a form ready for use/storage/transport.

It is also possible to preform an elastomeric member in a desired profile by, for example, an extrusion process which profile may thereafter be adhered to a glass substrate by manual or automated means. Typically, it will be desirable to apply the silane-based/isocyanate-based primers to either the glass substrate or to the preformed elastomeric member prior to the two components being brought into bonding contact. It may also be desirable to utilize other adhesives for certain applications of the present invention. In one preferred method, a jig or fixture is made to receive the glass substrate in a precise position, and adjacent thereto in, the jig/fixture, a channel for receiving the preformed elastomeric member is formed. Application of pressure and/or heat facilitates bonding of the elastomeric member to the glass substrate. At this point, the product produced by either in-situ molding or bonding of the preformed elastomeric member is, desirably, essentially the same.

The styrene-ethylene-butylene-styrene copolymer suitable for use in connection with the present invention includes, for example, various styrene block copolymers.

The thermoplastic urethane material suitable for use in connection with the present invention includes, for example, Ellastolan™ (BASF) and Pellathane™ (DOW Automotive). As previously noted, if the silane-based primer material and the isocyanate-based material are applied separately in a step-wise fashion, the isocyanate primer should be applied over the silane primer within a relatively short period of time. Typically, this time interval is between 2 seconds and 10 minutes. Preferably, the time interval is between 2 seconds and 2 minutes. Most preferably, the time interval between application of the respective primer layers is between 2 seconds and 60 seconds.

### EXAMPLES

Comparative Examples 1-6 were 1 inch by 6 inch pieces of Pilkington EZ-KOOL® green automotive glass to which ceramic enamel JM 355 Frit had been applied around a portion of the periphery thereof. All the samples were pre-heated to a temperature of 200° F. For comparative Examples 1 and 4, a mixture of Dow Betaseal 43518® and Lord Chemical ChemLok® 487 A/B primers were then applied to the glass in the areas where the ceramic frit was present. Santoprene® 121-75M 1004 thermoplastic vulcanizate TPV material was then molded onto the peripheral portions of the glass where the primer mixture was present. The samples were then allowed to cure for 30 minutes.

The same process described for comparative Examples 1 and 4 were utilized for Comparative Examples 2 and 5, except that the Betaseal 43518® and ChemLok® 487 A/B primers were applied separately, rather than as a mixture, and the polymeric material molded onto the glass was a SEBS material, namely Vichem Sevrene™ 3570-80-8843.

Comparative Examples 3 and 6 were prepared by the same methodology for Comparative Examples 2 and 5, except that the material molded onto the periphery of the primed glass samples was a TPE material, namely GLS Kraton™ G7820-9001-00.

Examples 1 and 2, in accordance with the invention, were prepared according to the same methodology as Comparative Examples 2, 3, 5 and 6, except that the second primer applied was Dow Betaseal 43520A®, and the polymeric material molded onto the primed glass was a SEBS/TPU TPE material, namely GLS LC 303-123.

For purposes of testing the strength and related properties of the bond of the molded-on polymeric material to the glass samples prepared as described above, Example 1, and Comparative Examples 1-3 were tested at ambient room temperature, or 72° F., whereas Example 2 and Comparative Examples 3-6 were tested at 80° C. (176° F.). The specification against which the sample results were compared is:
Initial Shear Strength Specification>0.5 MPa & 100% Material Breaking
Initial Peel Strength Specification>50 N/25 mm & 100% Material Breaking
Hot (80 C) Shear Strength Specification>0.2 MPa & 100% Material Breaking
Hot (80 C) Peel Strength Specification>15N/25 mm & 100% Material Breaking

The pull tests were performed on an Instron Universal Test Machine 42.01 at a pull rate of 200 mm/min.

As can be seen in Table 1 below, the subject SEBS/TPU material of Examples 1 and 2, in accordance with the invention, particularly in combination with primers of the type described elsewhere herein, meets or exceeds stringent OEM bonding specifications and is superior in performance to the other polymeric material/primer systems tested.

TABLE 1

| | | | | | Shear | | Peel | | |
|---|---|---|---|---|---|---|---|---|---|
| | Material | | Primer | Primer | Strength | Failure | Strength | Failure | |
| Condition | Type | Material | #1 | #2 | (Mpa) | Mode | (N/25 mm) | Mode | Results |
| Initial | | | | | | | | | |
| Example 1 in | TPE | GLS | 43518 | 43520A | 1.5 | 100% | 292 | 100% | PASS |
| accordance | | LC 303123 | | | | material | | material | |
| w/invention | | (80 durometer) | | | | breaking | | breaking | |
| Comparative | TPV | Santoprene ® | 43518/487A/B | none | 0.9 | 100% | 138 | 89% | FAIL |
| Example 1 | | 121-75M1004 | (Mixture) | | | material | | material | |
| | | (75 durometer) | | | | breaking | | breaking | |
| Comparative | SEBS | Vichem | 43518 | 487A/B | 1.0 | 20% | 230 | 20% | FAIL |
| Example 2 | | Sevrene ™ | | | | material | | material | |
| | | 3570-80-8843 | | | | breaking | | breaking | |
| | | (80 durometer) | | | | | | | |
| Comparative | TPE | GLS Kraton ™ | 43518 | 487A/B | 1.4 | 80% | 293 | 0% | FAIL |
| Example 3 | | G7820-9001-00 | | | | material | | material | |
| | | (75 durometer) | | | | breaking | | breaking | |
| Hot 80° C. | | | | | | | | | |
| Example 2 in | TPE | GLS | 43518 | 43520A | 0.6 | 100% | 103 | 100% | PASS |
| accordance | | LC 303123 | | | | material | | material | |
| w/invention | | (80 durometer) | | | | breaking | | breaking | |
| Comparative | TPV | Santoprene ® | 43518/487A/B | none | 0.6 | 80% | 23 | 0% | FAIL |
| Example 4 | | 121-75M1004 | (Mixture) | | | material | | material | |
| | | (75 durometer) | | | | breaking | | breaking | |
| Comparative | SEBS | Vichem | 43518 | 487A/B | 0.6 | 0% | 90 | 0% | FAIL |
| Example 5 | | Sevrene ™ | | | | material | | material | |
| | | 3570-80-8843 | | | | breaking | | breaking | |
| | | (80 durometer) | | | | | | | |
| Comparative | TPE | GLS Kraton ™ | 43518 | 487A/B | 0.9 | 0% | 73 | 0% | FAIL |
| Example 6 | | G7820-9001-00 | | | | material | | material | |
| | | (75 durometer) | | | | breaking | | breaking | |

What is claimed is:

1. A method of adhering an elastomeric member comprising a blend of a styrene-ethylene-butylene-styrene (SEBS) copolymer and a thermoplastic poly-urethane (TPU) material to a glass sheet utilizing one or more of an isocyanate-based primer and a silane-based primer.

2. The method defined in claim 1, wherein the glass sheet is a vehicle glazing.

3. A method defined in claim 2, wherein the one or more primers is/are applied to at least a portion of the periphery of the vehicle glazing.

4. The method defined in claim 3, wherein the elastomeric member is molded onto at least a portion of the periphery of the vehicle glazing, to which the one or more primers has been applied, by one of an injection molding or reaction injection molding process.

5. The method defined in claim 3, wherein the elastomeric member to be adhered is preformed by one of a molding or extrusion process.

6. The method defined in claim 3, wherein an isocyanate-based primer is applied over a previously applied silane-primer on the vehicle glazing.

7. The method defined in claim 3, wherein a silane-based primer is applied to a portion of the periphery of the vehicle glazing, and within a time interval between 2 seconds and 10 minutes thereafter, an isocyanate-based primer is applied over the silane-based primer.

8. The method defined in claim 7, wherein the time interval between applying the silane-based primer and applying the isocyanate-based primer is between 2 seconds and 2 minutes.

9. The method defined in claim 8, wherein the time interval between applying the silane-based primer and applying the isocyanate-based primer is between 2 seconds and 10 seconds.

10. The method defined in claim 3, wherein a mixture of a silane-based primer and an isocyanate-based primer is applied to at least a portion of the periphery of the vehicle glazing.

11. The method defined in claim 5, wherein the vehicle glazing with one or more primers disposed thereon is preheated to a temperature of between 100° F. (24° C.) and 300° F. (135° C.) prior to adhering the preformed elastomeric member thereto.

12. The method defined in claim 1, wherein the strength of the bond between the elastomeric member and the glass sheet is at least equal to the cohesive strength of the material of the elastomeric member.
